(19) United States
(12) Patent Application Publication
(10) Pub. No.: US 2016/0153852 A1
(43) Pub. Date: Jun. 2, 2016

(54) TORQUE ADJUSTMENT AND MEASUREMENT SYSTEM

(71) Applicant: Mu-Chuan WU, Tainan City (TW)

(72) Inventor: Mu-Chuan WU, Tainan City (TW)

(21) Appl. No.: 14/558,277

(22) Filed: Dec. 2, 2014

(51) Int. Cl. G01L 3/10

(52) U.S. Cl. CPC G01L 3/104

(57) ABSTRACT

A torque adjustment and measurement system has a torque adjustment device, a torque measurement device and a torque calculation device. The torque adjustment device can vary a torsional drag force exerted by a torque-applying device on a torque generation mechanism. The torque measurement device can detect a displacement or rotational angle variation of the torque-applying device. The torque calculation device further precisely converts the displacement or rotational angle variation provided by the torque measurement device into a corresponding torque value. Being a systematic integration of the torque adjustment device, the torque measurement device and the torque calculation device allows the torque adjustment and measurement system to be applied to the field of fitness equipment for users to adjust torque setting of fitness equipment and precisely measure and acquire the torque value.

### BACKGROUND OF THE INVENTION

1. Field of the Invention

The present invention relates to a torque adjustment and measurement system and, more particularly, to a torque adjustment and measurement system applied to fitness equipment for adjusting torque and accurately measuring torque value.

2. Description of the Related Art

To provide torque setting at different torque levels based on physical condition or stage of physical training of users, conventional fitness equipment, such as exercise bikes, includes a torque measurement device in addition to a torque adjustment device connected to a torque-applying device exerting force on a torque generation mechanism thereof The torque measurement device is electrically connected to an existing controller in the fitness equipment for users to adjust the magnitude of a torsional drag force exerted by the torque-applying device on the torque generation mechanism. The torque measurement device measures the torsional drag force after the adjustment and the controller displays the value of the adjusted torsional drag force.

However, the torque adjustment device, the torque measurement device and the controller in the conventional fitness equipment are independently developed mechanisms with their own dedicated functionalities. The consequence of such independent development leads to the difficulty of setting torque level and accurately measuring adjusted torque value when users are operating the conventional fitness equipment.

### SUMMARY OF THE INVENTION

An objective of the present invention is to provide a torque adjustment and measurement system resolving the infeasibility of an integrated system for torque adjustment and accurate torque measurement.

To achieve the foregoing objective, the torque adjustment and measurement system has a torque adjustment device, a torque measurement device and a torque calculation device.

The torque adjustment device is adapted to connect with a torque-applying device and adjust a torque exerted by the torque-applying device on a torque generation mechanism.

The torque measurement device measures a variation in displacement or in rotation angle of the torque-applying device.

The torque calculation device has a controller and a display.

The controller is electrically connected to the torque measurement device, and converts the variation in displacement or rotation angle of the torque-applying device provided by the torque measurement device into a corresponding torque value.

The display is electrically connected to the controller, and displays the torque value.

Given the foregoing toque adjustment and measurement system, the torque adjustment and measurement system is indeed a combination of the torque adjustment device, the torque measurement device and the torque calculation device. The torque adjustment device serves to alter a torsional drag force exerted by the torque-applying device on a torque generation mechanism. The torque measurement device serves to measure a variation of the torque-applying device in displacement or in rotational angle. The torque calculation device serves to accurately convert the variation in displacement or in rotational angle provided by the torque measurement device into a torque value. The information output unit then outputs the torque value to users. In view of a systematic integration of the torque adjustment device, the torque measurement device and the torque calculation device allows the torque adjustment and measurement system to be applied to the field of fitness equipment for users to adjust torque setting of fitness equipment and precisely measure and acquire the torque value.

Other objectives, advantages and novel features of the invention will become more apparent from the following detailed description when taken in conjunction with the accompanying drawings.

### BRIEF DESCRIPTION OF THE DRAWINGS

FIG. 1 is a partial side view of a first embodiment of a torque adjustment and measurement system in accordance with the present invention, applied to an exercise bike;

FIG. 2 is a partial side view of a second embodiment of a torque adjustment and measurement system in accordance with the present invention, applied to an exercise bike;

FIG. 3 is a partial side view in partial section of the torque adjustment and measurement system in FIG. 2, applied to an exercise bike;

FIG. 4 is an operating partial side view in partial section of the torque adjustment and measurement system in FIG. 2, applied to an exercise bike;

FIG. 5 is a perspective view of a torque adjustment device of a third embodiment of a torque adjustment and measurement system in accordance with the present invention, applied to an exercise bike; and

FIG. 6 is a partial side view of a fourth embodiment of a torque adjustment and measurement system in accordance with the present invention, applied to an exercise bike.

### DETAILED DESCRIPTION OF THE INVENTION

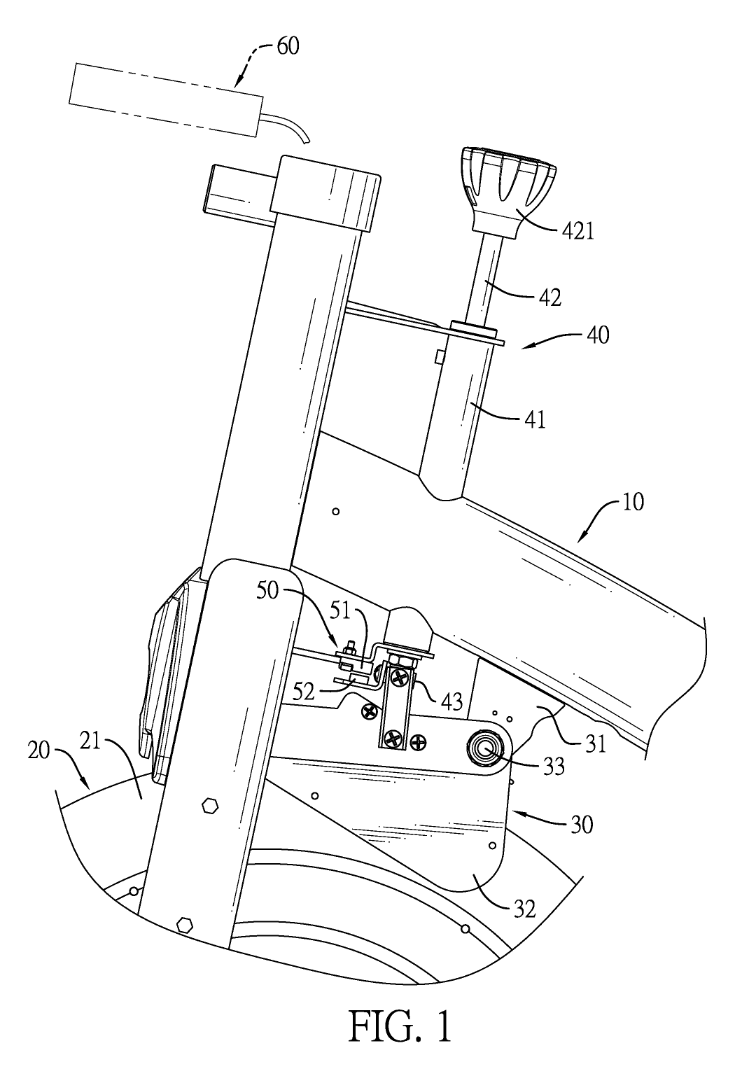

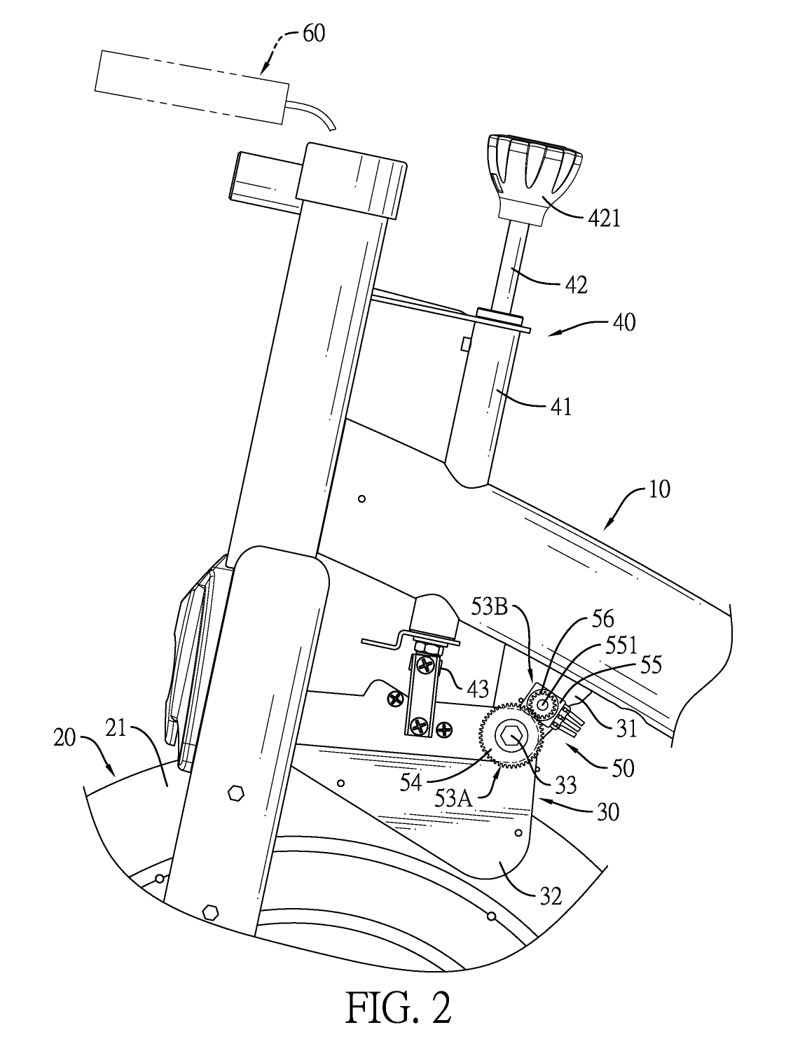

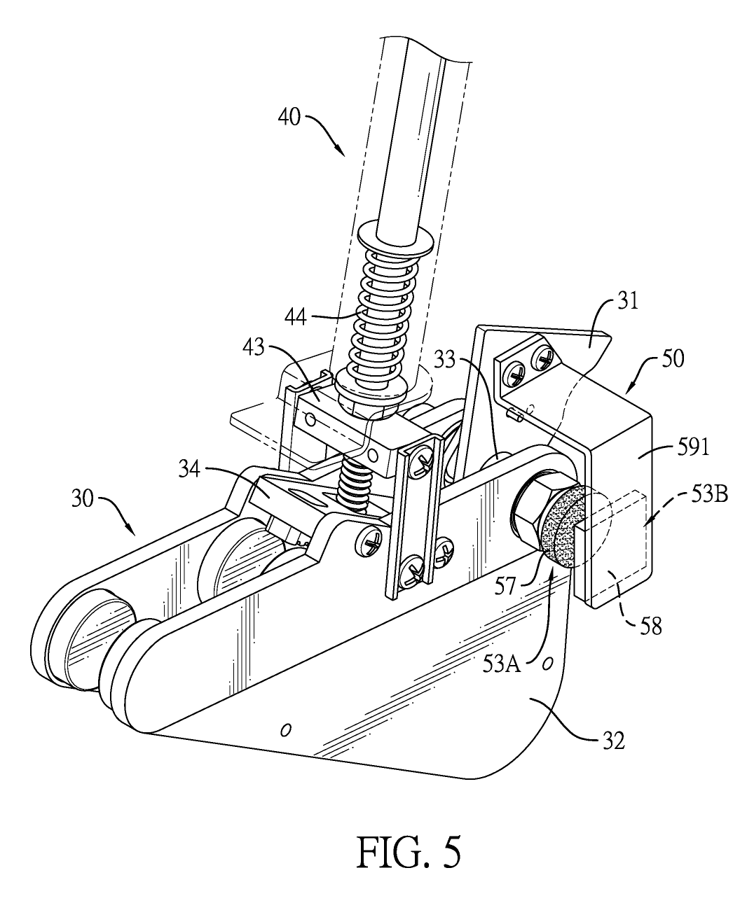

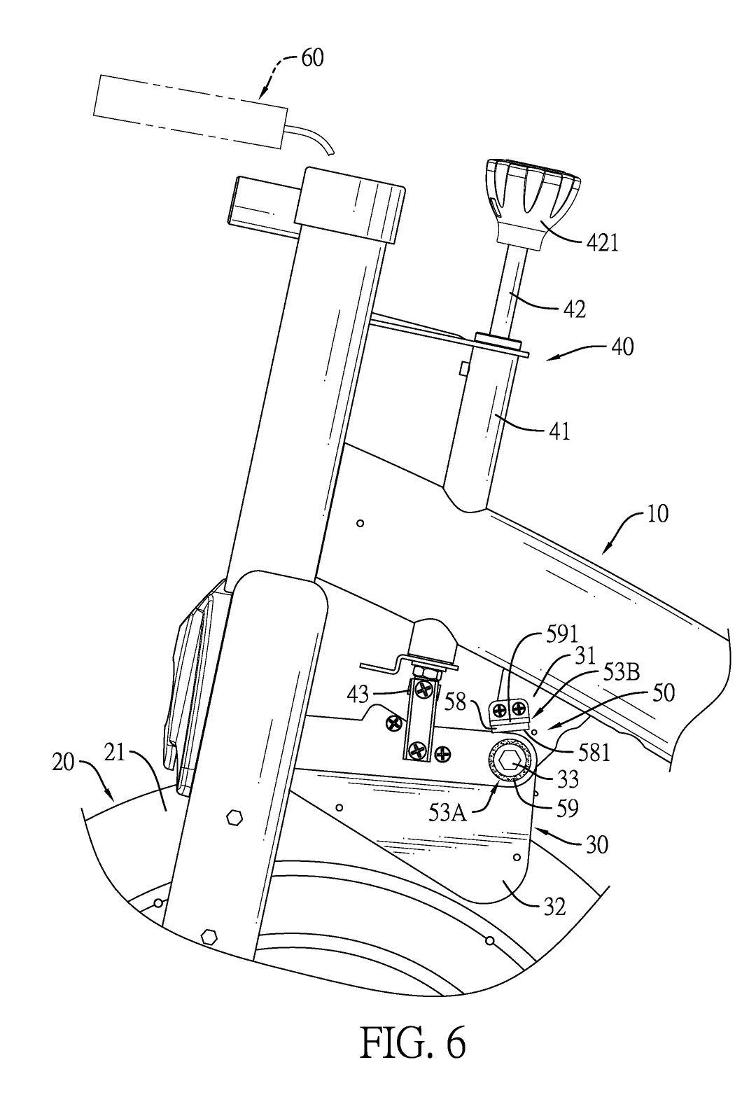

With reference to FIGS. 1 to 6, several embodiments associated with a torque adjustment and measurement system in accordance with the present invention and applied to fitness equipment are shown, specifically, a first embodiment illustrated on FIG. 1, a second embodiment illustrated on FIGS. 2 to 4, a third embodiment illustrated on FIG. 5, and a fourth embodiment illustrated on FIG. 6. The fitness equipment of those embodiments is chosen to be an exercise bike. With reference to FIGS. 1 to 3, the exercise bike has a frame 10, a torque generation mechanism 20 and a torque-applying device 30. The torque generation mechanism 20 has a wheel 21 pivotally mounted on the frame 10. The torque-applying device 30 has a fixture 31, a rocking piece 32, a rotation shaft 33, a driving block 34 and a torsional spring. The fixture 31 is mounted on a portion of the frame 10 adjacent to the wheel 21 of the torque generation mechanism 20. The rotation shaft 33 with the torsional spring mounted around the rotation shaft 33 is mounted through one edge portion of the rocking piece 32 and mounted on the fixture 31, such that two ends of the torsional spring respectively abut against the fixture 31 and the rocking piece 32, and the rocking piece 32 and the rotation shaft 33 are pivotable in an angular range relative to the fixture 31. The driving block 34 is mounted on the rocking piece 32, contacts an outer edge of the wheel 21, and drives the wheel 21 with a torque acted on the driving block 34.

Each embodiment of the torque adjustment and measurement system in accordance with the present invention includes a torque adjustment device 40, a torque measurement device 50 and a torque calculation device 60.

With reference to FIG. 1, the torque adjustment device 40 is a manually-driven or an electrically-driven mechanism, and serves to connect the torque-applying device 30 for users to vary a torque exerted by the torque-applying device 30 on the torque generation mechanism 20 through the torque adjustment device by a manually-driven or electrically-driven means.

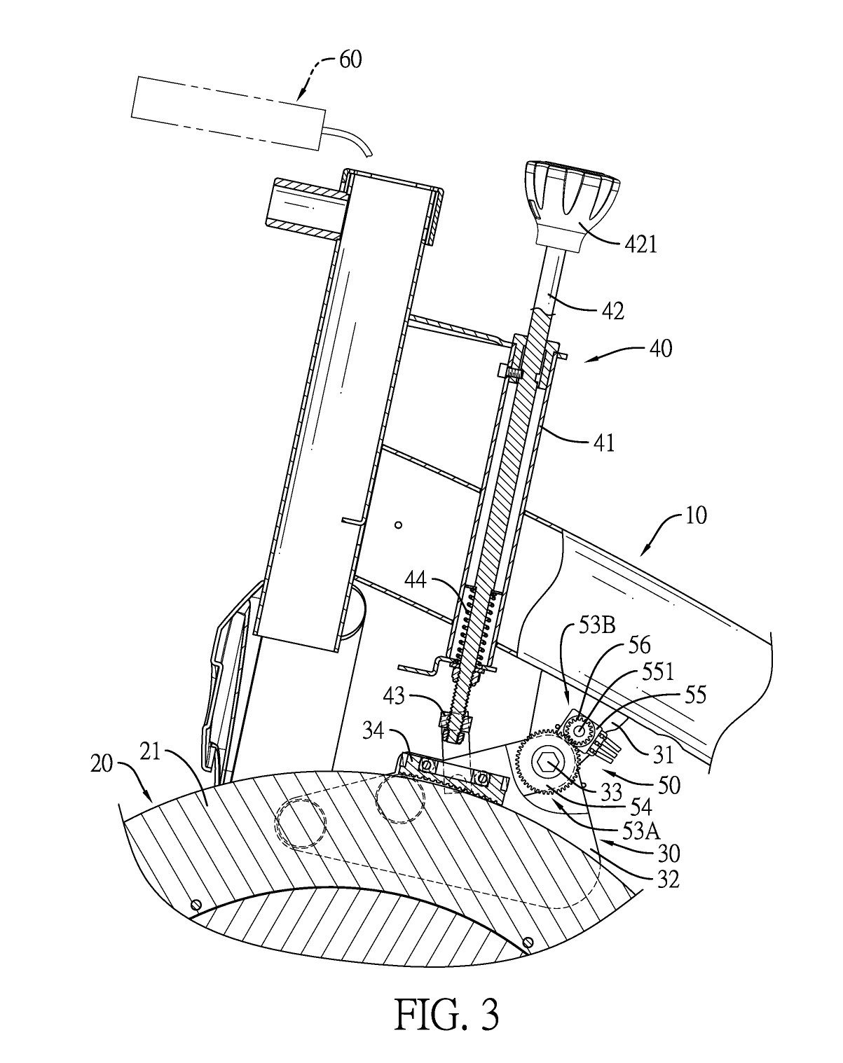

With reference to FIG. 3, the torque adjustment device 40 has a tube 41, an adjustment rod 42, a movable piece 43 and a compression spring 44. The tube 41 is securely mounted on the frame 10 of the exercise bike and is adjacent to the wheel 21 and the torque-applying device 30 of the exercise bike. A bottom end of the tube 41 is a fixing end. The adjustment rod 42 is mounted inside the tube 41, is rotatable around a fixed point because an annular slot is formed in the adjustment rod 42 and a bolt is mounted through the tube 41 and is positioned in the annular slot, and has a threaded portion and a knob 421. The threaded portion is mounted through the fixing end of the tube 41 and is mounted in the movable piece 43. The knob 421 is mounted on an outer end of the adjustment rod 42 extending beyond the tube 41. The movable piece 43 is mounted on the rocking piece 32 and has a threaded hole for the threaded portion of the adjustment rod 42 to engage the threaded hole. The compression spring 44 is mounted around the adjustment rod 42 with one end of the compression spring 44 fastened on the adjustment rod 42 and the other end abutting against the fixing end of the tube 41. Thus, when users hold the knob 421 of the adjustment rod 42 to rotate the adjustment rod 42, the adjustment rod 42 drives the rocking piece 32 to rotate with respect to a rotation axis of the rotations haft 33 through the movable piece 43, such that a torsional drag force exerted on the wheel 21 by the driving block 34 mounted on the rocking piece 32 and contacting the wheel 21 can be adjusted.

When being an electrically-driven mechanism, the torque adjustment device 40 has an electric motor, a stud and a movable piece. A spindle of the electric motor is connected with the stud. The movable piece is mounted on the rocking piece 32 of the torque-applying device 30. The stud is mounted through the movable piece and is screwed therein. When the electric motor drives the stud to rotate and move in a forward or reverse direction, the stud pushes the movable piece to rotate the rocking piece 32 with respect to the rotation axis of the rotation shaft 33, such that the torsional drag force exerted on the wheel 21 by the driving block 34 can be adjusted.

The torque measurement device 50 may pertain to a displacement measurement mechanism or a rotation angle measurement mechanism. The torque measurement device 50 is connected with the rocking piece 32 having the driving block 34 mounted thereon, and serves to measure a displacement variation or an angular variation of the rocking piece 32.

The torque calculation device 60 has a controller and an information output unit. The controller is electrically connected to the torque measurement device 50. In the present embodiment, the information output unit is a display. The torque calculation device 60 converts the displacement variation or the angular variation of the rocking piece 32 provided by the torque measurement device 50 into a corresponding torque value, and outputs the torque value through the information output unit. The torque calculation device 60 can reset the torque value to zero and issue an alarm when the torque value is greater than a threshold value.

When pertaining to a displacement measurement mechanism, the torque measurement device 50 may be a contact-type sensing element, such as a variable resistance sensor, or a contactless sensing element, such as a magnetic sensor.

When the torque measurement device 50 is a variable resistance sensor, the variable resistance sensor is connected with the frame 10 and is mounted between the rocking piece 32 and the movable piece 43, and is electrically connected to the controller of the torque calculation device 60. The variable resistance sensor generates a resistance variation corresponding to a positional variation of the movable piece 43 on the rocking piece 323 relative to the frame 10 or the fixture 31. The controller of the torque calculation device 60 calculates a torque value corresponding to a voltage variation across a variable resistor of the variable resistance sensor corresponding to the resistance variation, and displays the torque value through a display.

When pertaining to a contactless sensing element, the torque measurement device 50 includes a master sensing element and a slave sensing element. One of the master sensing element and the slave sensing element is selectively mounted on a fixed portion of the torque-applying device 30, and the other of the master sensing element and the slave sensing element is mounted on a movable portion of the torque-applying device 30, such as the movable piece 43, capable of being adjusted by the torque adjustment device 40. The master sensing element faces but does not contact the slave sensing element. The master sensing element is electrically connected to the controller of the torque calculation device 60, and contactlessly senses a variation of a relative distance between the master sensing element and the slave sensing element to generate a corresponding signal.

With further reference to FIG. 1, the contactless torque measurement device 50 is a magnetic type sensing element, which includes a sensing integrated circuit (IC) element 51 and a magnetic element 52. The sensing IC element 51, such as a Hall effect sensor and the like, is taken as the master sensing element and is electrically connected to the controller of the torque calculation device 60. The magnetic element 52, such as a permanent magnet and the like, is taken as the slave sensing element. A variation of a relative distance between the sensing IC element 51 and the magnetic element 52 gives rise to a flux variation. The controller of the torque calculation device 60 calculates a torque value according to the flux variation varying with the variation of the relative distance between the sensing IC element 51 and the magnetic element 52, and displays the torque value through the display.

With further reference to FIGS. 2 and 3, when serving to measure an angular angle, the torque measurement device 50 includes a driven rotation element 53A and an angle measurement element 53B. The driven rotation element 53A is mounted around the rotation shaft 33 of the torque-applying device 30 to rotate along with the rotation shaft 33 of the torque-applying device 30 in a fixed angular range. The angle measurement element 53B is mounted on an outer periphery of the torque-applying device 30, measures a rotational angle from the driven rotation element 53A, and generates a signal corresponding to the rotational angle.

The driven rotation element 53A has a first driven gear 54 securely mounted around the rotation shaft 33 of the torque-applying device 30 and driven by the rotation shaft 33 to be rotatable along with the rocking piece 32 and the rotation shaft 33. The angle measurement element 53B has a variable resistor 55 and a second driven gear 56. The variable resistor 55 is mounted on the outer periphery of the torque-applying device 30, and is electrically connected to the external torque calculation device 60. The variable resistor 55 has a rotary shaft 551. A resistance value of the variable resistor 55 varies with a rotational angle of the rotary shaft 551. The second driven gear 56 is securely mounted around an end portion of the rotary shaft 551, engages the first driven gear 54, and is preferably less than the first driven gear 54 in diameter. In the present embodiment, a gear ratio of the first driven gear to the second driven gear is 2:1.

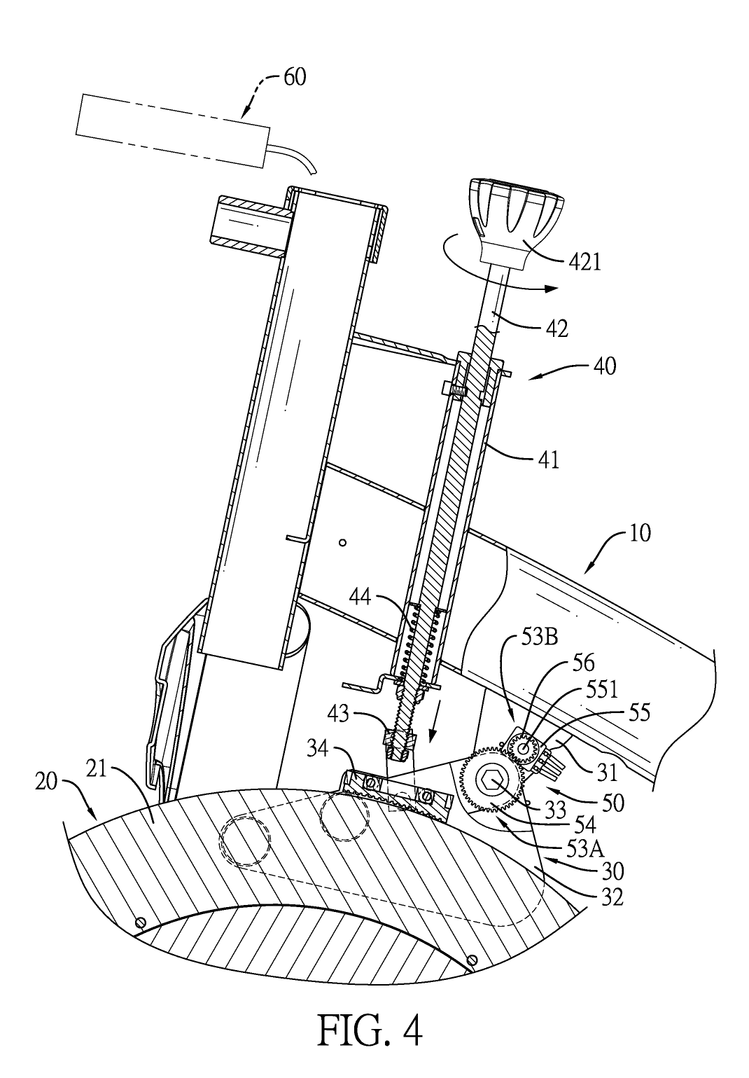

With reference to FIG. 4, when the torque adjustment device 40 drives the rocking piece 32 of the torque-applying device 30 to rotate with respect to the rotation shaft 33, the force exerted by the driving block 34 of the rocking piece 32 on the wheel 21 is adjusted. The first driven gear 54 is rotated along with the rocking piece 32 to drive the second driven gear 56 engaging the first driven gear 54 to rotate, such that the resistance value varies with the rotational angle of the second driven gear 56. Thus, the torque calculation device 60 electrically connected with the variable resistor 55 can convert a signal generated according to the variation of the resistance value of the variable resistor 55 into a corresponding torque value, and displays the torque value on a display thereof

With reference to FIG. 5, the driven rotation element 53A has a disc-shaped permanent magnet 57 securely mounted on an outer end face of the rotation shaft 33 of the torque-applying device 30, and is driven by the rotation shaft 33 to rotate along with the rocking piece 32 of the torque-applying device 30. The angle measurement element 53B includes a rotation sensing IC 58 mounted on a bracket 591, which is mounted on an outer side of the rocking piece 32, and is electrically connected to the external torque calculation device 60. The rotation sensing IC 58 has a sensing portion 581 being adjacent to, but not contacting, an outer axial end of the permanent magnet 57, such that the rotation sensing IC 58 can sense a magnetic field varying with a rotational angle of the permanent magnet 57 to generate a signal.

When the torque adjustment device 40 drives the rocking piece 32 of the torque-applying device 30 to rotate with respect to the rotation shaft 33, the driving block 34 on the rocking piece 32 exerts force on the wheel 21 and the permanent magnet 57 on the rotation shaft 33 is also rotated, such that the rotation sensing IC 58 can sense a variation of the magnetic field according to a variation of the rotational angle of the permanent magnet 57. The controller of the torque calculation device 60 converts a signal generated from the variation of the magnetic field sensed by the rotation sensing IC 58 into a corresponding torque value and displays the torque value on the display.

With reference to FIG. 6, the driven rotation element 53A has a permanent magnet ring 59 securely mounted around an outer end of the rotation shaft 33 of the rocking piece 32 and rotated along with the rocking piece 32 with respect to the rotation shaft 33. The angle measurement element 53B has a rotation sensing IC 58. The rotation sensing IC 58 is securely mounted on the fixture 31 through an attachment frame 591, faces a circumferential edge of the permanent magnet ring 59, is electrically connected to the external torque calculation device 60, and has a sensing portion 581. The sensing portion 581 is adjacent to, but does not contact, the circumferential edge of the permanent magnet ring 59, and can sense a magnetic field varying with a rotational angle of the permanent magnet ring 59 to generate a signal. The controller of the torque calculation device 60 further converts the signal generated according to a variation of the magnetic field sensed by the rotation sensing IC 58 into a corresponding torque value, and displays the torque value on the display.

When the torque adjustment device 40 drives the rocking piece 32 of the torque-applying device 30 to rotate with respect to the rotation shaft 33, the driving block 34 on the rocking piece 32 exerts force on the wheel 21 and the permanent magnet ring 59 on the rotation shaft 33 is also rotated along with the rocking piece 32, such that the rotation sensing IC 58 can sense the magnetic field varying with the rotational angle of the permanent magnet ring 59 to generate a signal. The torque calculation device 60 further converts the signal generated according to a variation of the magnetic field sensed by the rotation sensing IC 58 into a corresponding torque value, and displays the torque value on the display thereof

Given a combination of the torque adjustment device 40, the torque measurement device 50 and the torque calculation device 60 in the present invention, the torque adjustment device 40 adjusts a torque exerted by the torque-applying device on the wheel, the torque measurement device 50 measures a variation in displacement or rotation angle of the torque-applying device, and the torque calculation device 60 further precisely converts a signal generated according to a variation of the displacement or rotation angle measured by the torque measurement device 50 into a torque value and provides the torque value to users through the information output unit.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A torque adjustment and measurement system, comprising:
a torque adjustment device adapted to connect with a torque-applying device and adjust a torque exerted by the torque-applying device on a torque generation mechanism, wherein the torque generation mechanism has a wheel pivotally mounted on a frame of fitness equipment, the torque-applying device has a fixture, a rocking piece and a rotation shaft with the fixture mounted on the frame of the fitness equipment and the rotation shaft mounted through the rocking piece for the rocking piece and the rotation shaft to be pivotable relative to the fixture;
a torque measurement device measuring a variation in displacement or in rotation angle of the torque-applying device; and
a torque calculation device having:
a controller electrically connected to the torque measurement device, and converting the variation in displacement or rotation angle of the torque-applying device provided by the torque measurement device into a torque value; and
an information output unit electrically connected to the controller, and displaying the torque value.

2. The torque adjustment and measurement system as claimed in claim 1, wherein the torque adjustment device has:
a tube having a bottom end serving as a fixing end;
an adjustment rod mounted inside the tube, being rotatable around a fixed point, and having a knob mounted on an outer end of the adjustment rod extending beyond the tube;
a movable piece mounted on the rocking piece of the torque-applying device, wherein an inner end of the adjustment rod is mounted through the fixing end of the tube and is mounted in the movable piece by means of threaded connection; and
a compression spring mounted around the adjustment rod with one end of the compression spring fastened on the adjustment rod and the other end of the compression spring abutting against the fixing end of the tube;
wherein the torque adjustment device is manually operated to adjust a torsional drag force exerted by the torque-applying device on the torque generation mechanism.

3. The torque adjustment and measurement system as claimed in claim 1, wherein the torque adjustment device has:
an electric motor having a spindle;
a stud connected with the spindle of the electric motor; and
a movable piece mounted on the torque-applying device, wherein the stud is mounted through the movable piece and is screwed therein, and when the electric motor drives the stud to rotate, the torque adjustment device adjusts a torsional drag force exerted by the torque-applying device on the torque generation mechanism.

4. The torque adjustment and measurement system as claimed in claim 1, wherein
the torque measurement device is a variable resistor connected to the torque-applying device and generating a resistance value varying with displacement of the torque-applying device; and
the controller of the torque calculation device converts a voltage variation across the variable resistor according to the resistance value into a corresponding torque value.

5. The torque adjustment and measurement system as claimed in claim 2, wherein
the torque measurement device is a variable resistor connected to the torque-applying device and generating a resistance value varying with displacement of the torque-applying device; and
the controller of the torque calculation device converts a voltage variation across the variable resistor according to the resistance value into a corresponding torque value.

6. The torque adjustment and measurement system as claimed in claim 3, wherein
the torque measurement device is a variable resistor connected to the torque-applying device and generating a resistance value varying with displacement of the torque-applying device; and
the controller of the torque calculation device converts a voltage variation across the variable resistor according to the resistance value into a corresponding torque value.

7. The torque adjustment and measurement system as claimed in claim 1, wherein
the torque measurement device is a contactless sensing element, and has a master sensing element and a slave sensing element, one of the master sensing element and the slave sensing element is selectively mounted on a fixed portion of the torque-applying device, and the other of the master sensing element and the slave sensing element is mounted on a movable portion of the torque-applying device, the master sensing element faces but does not contact the slave sensing element, is electrically connected to the torque calculation device, and contactlessly senses a variation of a relative distance between the master sensing element and the slave sensing element to generate a corresponding signal; and
the controller of the torque calculation device converts the variation of the relative distance between the master sensing element and the slave sensing element into a corresponding torque value.

8. The torque adjustment and measurement system as claimed in claim 2, wherein
the torque measurement device is a contactless sensing element, and has a master sensing element and a slave sensing element, one of the master sensing element and the slave sensing element is selectively mounted on a fixed portion of the torque-applying device, and the other of the master sensing element and the slave sensing element is mounted on a movable portion of the torque-applying device, the master sensing element faces but does not contact the slave sensing element, is electrically connected to the torque calculation device, and contactlessly senses a variation of a relative distance between the master sensing element and the slave sensing element to generate a corresponding signal; and
the controller of the torque calculation device converts the variation of the relative distance between the master sensing element and the slave sensing element into a corresponding torque value.

9. The torque adjustment and measurement system as claimed in claim 3, wherein
the torque measurement device is a contactless sensing element, and has a master sensing element and a slave sensing element, one of the master sensing element and the slave sensing element is selectively mounted on a fixed portion of the torque-applying device, and the other of the master sensing element and the slave sensing element is mounted on a movable portion of the torque-applying device, the master sensing element faces but does not contact the slave sensing element, is electrically connected to the torque calculation device, and contactlessly senses a variation of a relative distance between the master sensing element and the slave sensing element to generate a corresponding signal; and
the controller of the torque calculation device converts the variation of the relative distance between the master sensing element and the slave sensing element into a corresponding torque value.

10. The torque adjustment and measurement system as claimed in claim 1, wherein
the torque measurement device is a rotation angle measurement mechanism and has:
a driven rotation element mounted around a rotation shaft of the torque-applying device to rotate along with the rotation shaft of the torque-applying device in a fixed angular range; and
an angle measurement element mounted on an outer periphery of the torque-applying device, measuring a rotational angle from the driven rotation element, and generating a signal corresponding to the rotational angle; and
the controller of the torque calculation device converts the signal generated by the angle measurement element into a corresponding torque value.

11. The torque adjustment and measurement system as claimed in claim 2, wherein
the torque measurement device is a rotation angle measurement mechanism and has:
a driven rotation element mounted around a rotation shaft of the torque-applying device to rotate along with the rotation shaft of the torque-applying device in a fixed angular range; and
an angle measurement element mounted on an outer periphery of the torque-applying device, measuring a rotational angle from the driven rotation element, and generating a signal corresponding to the rotational angle; and
the controller of the torque calculation device converts the signal generated by the angle measurement element into a corresponding torque value.

12. The torque adjustment and measurement system as claimed in claim 3, wherein
the torque measurement device is a rotation angle measurement mechanism and has:
a driven rotation element mounted around a rotation shaft of the torque-applying device to rotate along with the rotation shaft of the torque-applying device in a fixed angular range; and
an angle measurement element mounted on an outer periphery of the torque-applying device, measuring a rotational angle from the driven rotation element, and generating a signal corresponding to the rotational angle; and
the controller of the torque calculation device converts the signal generated by the angle measurement element into a corresponding torque value.

13. The torque adjustment and measurement system as claimed in claim 10, wherein
the driven rotation element has a first driven gear securely mounted around the rotation shaft of the torque-applying device and driven by the rotation shaft to be rotatable along with the rocking piece and the rotation shaft of the torque-applying device; and
the angle measurement element has:
a variable resistor mounted on the outer periphery of the torque-applying device, electrically connected to the torque calculation device, and having a rotary shaft, wherein a resistance value of the variable resistor varies with a rotational angle of the rotary shaft; and
a second driven gear securely mounted around an end portion of the rotary shaft and engaging the first driven gear.

14. The torque adjustment and measurement system as claimed in claim 11, wherein
the driven rotation element has a first driven gear securely mounted around the rotation shaft of the torque-applying device and driven by the rotation shaft to be rotatable along with the rocking piece and the rotation shaft of the torque-applying device; and
the angle measurement element has:
a variable resistor mounted on the outer periphery of the torque-applying device, electrically connected to the torque calculation device, and having a rotary shaft, wherein a resistance value of the variable resistor varies with a rotational angle of the rotary shaft; and
a second driven gear securely mounted around an end portion of the rotary shaft and engaging the first driven gear.

15. The torque adjustment and measurement system as claimed in claim 12, wherein
the driven rotation element has a first driven gear securely mounted around the rotation shaft of the torque-applying device and driven by the rotation shaft to be rotatable along with the rocking piece and the rotation shaft of the torque-applying device; and
the angle measurement element has:
a variable resistor mounted on the outer periphery of the torque-applying device, electrically connected to the torque calculation device, and having a rotary shaft, wherein a resistance value of the variable resistor varies with a rotational angle of the rotary shaft; and
a second driven gear securely mounted around an end portion of the rotary shaft and engaging the first driven gear.

16. The torque adjustment and measurement system as claimed in claim 10, wherein
the driven rotation element has a disc-shaped permanent magnet securely mounted on an outer end face of the rotation shaft of the torque-applying device, and driven by the rotation shaft to rotate along with the rocking piece of the torque-applying device;
the angle measurement element includes a rotation sensing IC (Integrated Circuit) mounted on an outer side of the rocking piece through a bracket, electrically connected to the torque calculation device, and having a sensing portion being adjacent to but not contacting an outer axial end of the permanent magnet to sense a magnetic field varying with a rotational angle of the permanent magnet in generation of a signal; and
the controller of the torque calculation device converts the signal generated by the rotation sensing IC into a corresponding torque value.

17. The torque adjustment and measurement system as claimed in claim 11, wherein
the driven rotation element has a disc-shaped permanent magnet securely mounted on an outer end face of the rotation shaft of the torque-applying device, and driven by the rotation shaft to rotate along with the rocking piece of the torque-applying device;
the angle measurement element includes a rotation sensing IC (Integrated Circuit) mounted on an outer side of the rocking piece through a bracket, electrically connected to the torque calculation device, and having a sensing portion being adjacent to but not contacting an outer axial end of the permanent magnet to sense a magnetic field varying with a rotational angle of the permanent magnet in generation of a signal; and
the controller of the torque calculation device converts the signal generated by the rotation sensing IC into a corresponding torque value.

18. The torque adjustment and measurement system as claimed in claim 12, wherein
the driven rotation element has a disc-shaped permanent magnet securely mounted on an outer end face of the rotation shaft of the torque-applying device, and driven by the rotation shaft to rotate along with the rocking piece of the torque-applying device;
the angle measurement element includes a rotation sensing IC (Integrated Circuit) mounted on an outer side of the rocking piece through a bracket, electrically connected to the torque calculation device, and having a sensing portion being adjacent to but not contacting an outer axial end of the permanent magnet to sense a magnetic field varying with a rotational angle of the permanent magnet in generation of a signal; and
the controller of the torque calculation device converts the signal generated by the rotation sensing IC into a corresponding torque value.

19. The torque adjustment and measurement system as claimed in claim 10, wherein
the driven rotation element has a permanent magnet ring securely mounted around an outer end of the rotation shaft on the rocking piece and rotated along with the rocking piece with respect to the rotation shaft;
the angle measurement element has a rotation sensing IC securely mounted on the fixture of the torque-applying device through an attachment frame, facing a circumferential edge of the permanent magnet ring, electrically connected to the external torque calculation device, and having a sensing portion, wherein the sensing portion is adjacent to but does not contact the circumferential edge of the permanent magnet ring, and senses a magnetic field varying with a rotational angle of the permanent magnet ring to generate a signal; and
the controller of the torque calculation device further converts the signal generated according to the magnetic field sensed by the rotation sensing IC into a corresponding torque value.

20. The torque adjustment and measurement system as claimed in claim 11, wherein
the driven rotation element has a permanent magnet ring securely mounted around an outer end of the rotation shaft on the rocking piece and rotated along with the rocking piece with respect to the rotation shaft;
the angle measurement element has a rotation sensing IC securely mounted on the fixture of the torque-applying device through an attachment frame, facing a circumferential edge of the permanent magnet ring, electrically connected to the external torque calculation device, and having a sensing portion, wherein the sensing portion is adjacent to but does not contact the circumferential edge of the permanent magnet ring, and senses a magnetic field varying with a rotational angle of the permanent magnet ring to generate a signal; and
the controller of the torque calculation device further converts the signal generated according to the magnetic field sensed by the rotation sensing IC into a corresponding torque value.
